(19) United States
(12) Patent Application Publication
(10) Pub. No.: US 2023/0208215 A1
(43) Pub. Date: Jun. 29, 2023

(54) ROTATING ELECTRICAL MACHINE

(71) Applicant: Nidec Corporation, Kyoto (JP)

(72) Inventors: Akira ICHIEN, Kyoto (JP); Shota KAWASHIMA, Kyoto (JP); Kentaro SEKI, Kyoto (JP)

(21) Appl. No.: 18/079,034

(22) Filed: Dec. 12, 2022

(30) Foreign Application Priority Data
Dec. 28, 2021 (JP) 2021-214904

(51) Int. Cl. H02K 1/14; H02K 15/02; H02K 1/02

(52) U.S. Cl. CPC H02K 1/148; H02K 15/022; H02K 1/02; H02K 3/525

(57) ABSTRACT

A rotating electrical machine includes a rotor and a stator including an annular stator core including core pieces connected to each other in a circumferential direction. Each of the core pieces includes a core back piece extending in the circumferential direction and a tooth radially extending from the core back piece. At least one of the coupling portions between the core back pieces adjacent in the circumferential direction is a first coupling portion. Each of the pair of core back pieces connected in the circumferential direction via the first coupling portion includes a first surface and a second surface continuously connected to the first surface in the radial direction. In the pair of core back pieces connected in the circumferential direction, the first surface of one core back piece and the first surface of the other core back piece are in contact with each other.

### CROSS-REFERENCE TO RELATED APPLICATIONS

The present application claims priority under 35 U.S.C. § 119 to Japanese Patent Application No. 2021-214904, filed on Dec. 28, 2021, the entire contents of which are hereby incorporated herein by reference.

### 1. Field of the Invention

The present disclosure relates to a rotating electrical machine.

### 2. Background

Conventionally, a rotating electrical machine including a plurality of divided cores for which stators are disposed in a circumferential direction is known.

In the rotating electrical machine as described above, an unintended gap may be generated between the divided cores connected in the circumferential direction due to dimensional tolerance or the like. Therefore, there is a problem that the magnetic flux hardly flows through the coupling portion between the divided cores connected in the circumferential direction, and the torque ripple increases.

### SUMMARY

A rotating electrical machine according to an example embodiment of the present invention includes a rotor rotatable about a center axis, and a stator including an annular stator core including core pieces connected to each other in a circumferential direction, the stator radially opposing the rotor with a gap interposed therebetween. Each of the core pieces includes a core back piece extending in the circumferential direction and a tooth radially extending from the core back piece. The core back pieces are connected to each other in the circumferential direction to define an annular core back. At least one of coupling portions between the core back pieces adjacent to each other in the circumferential direction is a first coupling portion. Each of the pair of core back pieces connected in the circumferential direction via the first coupling portion includes a first surface and a second surface continuously connected to the first surface in a radial direction. In the pair of core back pieces connected in the circumferential direction via the first coupling portion, the first surface of one core back piece and the first surface of the other core back piece are in contact with each other, and the second surface of the one core back piece and the second surface of the other core back piece are directed away from each other.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a cross-sectional view illustrating a rotating electrical machine of a first example embodiment of the present disclosure.

FIG. 2 is a perspective view illustrating a stator core of the first example embodiment.

FIG. 3 is a view of the stator core of the first example embodiment when viewed in the axial direction.

FIG. 4 is a view of a core piece group of the stator core of the first example embodiment when viewed in the axial direction.

FIG. 5 is a view illustrating a first coupling portion of the first example embodiment.

FIG. 6 is a perspective view illustrating a portion of a stator core of the first example embodiment.

FIG. 7 is a flowchart illustrating a method of manufacturing the stator according to the first example embodiment.

FIG. 8 is a diagram illustrating a portion of the procedure of the method of manufacturing the stator according to the first example embodiment.

FIG. 9 is a view illustrating a first coupling portion of a second example embodiment of the present disclosure.

FIG. 10 is a view of a stator core according to a third example embodiment of the present disclosure when viewed in the axial direction.

### DETAILED DESCRIPTION

In the following descriptions of example embodiments of the present disclosure, a center axis J illustrated in the drawing is an imaginary axis indicating the center axis of the rotating electrical machine as appropriate. In the following description, unless otherwise particularly stated, a direction parallel to the center axis J is simply referred to as an “axial direction”, a radial direction about the center axis J is simply referred to as a “radial direction”, and a circumferential direction about the center axis J, that is, a direction around the center axis J is simply referred to as a “circumferential direction”.

An arrow θ appropriately illustrated in each figure indicates the circumferential direction. A side (+θ side) to which the arrow θ is directed in the circumferential direction is referred to as “one circumferential direction side”. One circumferential direction side is a clockwise side around the center axis J when viewed from the side (+Z side) to which the arrow of the Z axis is directed. A side (−θ side) opposite to the side to which the arrow θ is directed in the circumferential direction is referred to as “the other circumferential direction side”. The other circumferential direction side is a counterclockwise side around the center axis J when viewed from the side to which the arrow of the Z axis is directed. In the following descriptions of example embodiments of the present disclosure, the radially inner side corresponds to “one radial direction side”, and the radially outer side corresponds to “the other radial direction side”.

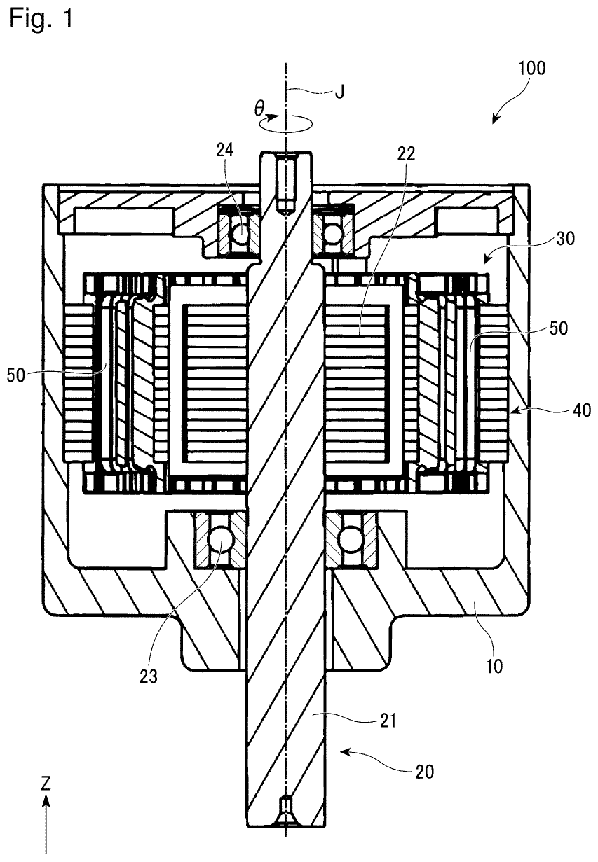

As illustrated in FIG. 1, a rotating electrical machine 100 of the present example embodiment is an inner rotor type motor. The rotating electrical machine 100 includes a housing 10, a rotor 20, and a stator 30. The housing 10 accommodates the rotor 20 and the stator 30 therein. The rotor 20 is rotatable about the center axis J. The rotor 20 includes a shaft 21 extending in the axial direction about the center axis J, and a rotor body 22 fixed to the outer peripheral face of the shaft 21. The shaft 21 is rotatably supported about the center axis J by a pair of bearings 23 and 24 held by the housing 10. Although not illustrated, the rotor body 22 includes a rotor core fixed to the shaft 21 and a magnet fixed to the rotor core.

The stator 30 faces the rotor 20 with a gap interposed therebetween. In the present example embodiment, the stator 30 is located radially outside of the rotor 20. The stator 30 has an annular shape surrounding the rotor 20. The stator 30 includes a stator core 40 and a plurality of coils 50 attached to the stator core 40.

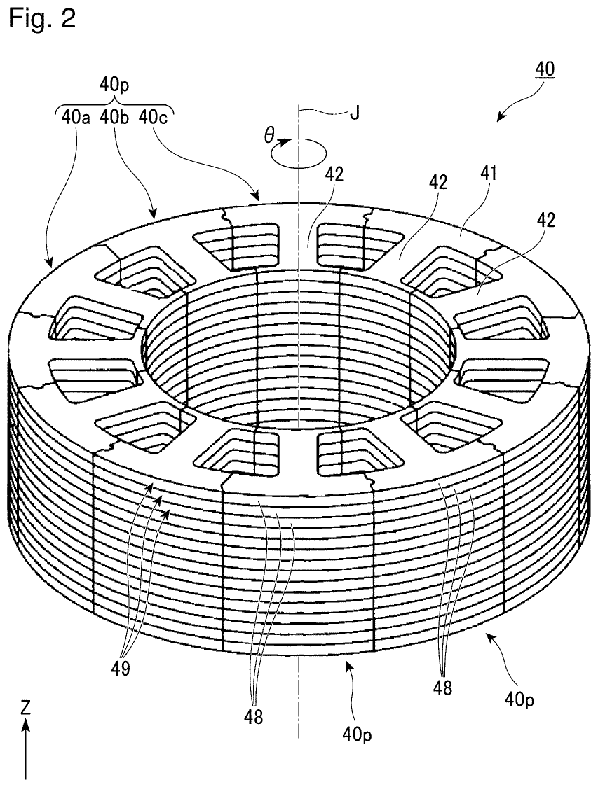

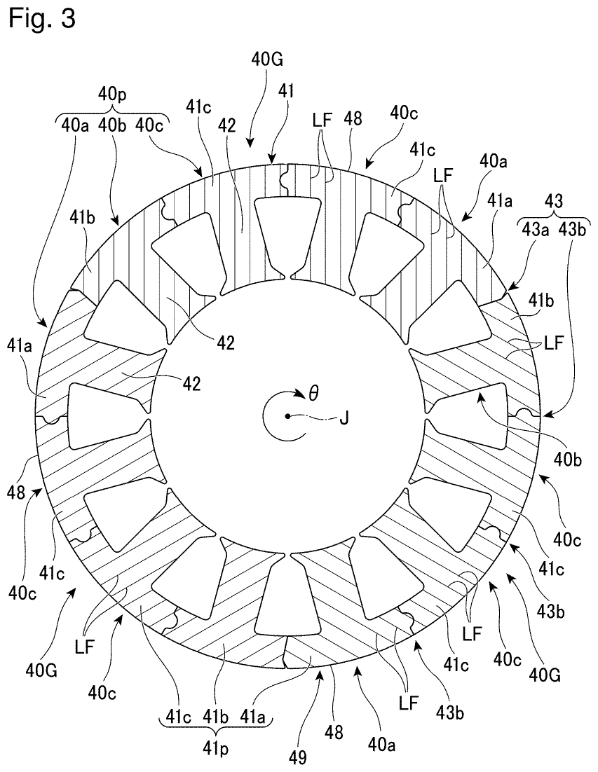

As illustrated in FIGS. 2 and 3, the stator core 40 has an annular shape surrounding the center axis J. More specifically, the stator core 40 has an annular ring shape about the center axis J. The stator core 40 includes a core back 41 and a plurality of teeth 42. The core back 41 has an annular shape surrounding the center axis J. More specifically, the core back 41 has an annular ring shape about the center axis J. The plurality of teeth 42 extend radially inward from the core back 41. The plurality of teeth 42 are disposed side by side at intervals in the circumferential direction. The plurality of teeth 42 is disposed at equal intervals over the entire circumference in the circumferential direction. One coil 50 is attached to each tooth 42.

The stator core 40 is configured by a plurality of core pieces 40p connected to each other in the circumferential direction. As illustrated in FIG. 3, each of the plurality of core pieces 40p includes a core back piece 41p extending in the circumferential direction and tooth 42 extending in the radial direction from the core back piece 41p. Each core piece 40p has one core back piece 41p and one tooth 42. The core back pieces 41p pf the plurality of core pieces 40p are connected in the circumferential direction to constitute the annular core back 41. In the present example embodiment, 12 core pieces 40p are provided.

In the present example embodiment, the plurality of core pieces 40p includes three types of core pieces 40p of a first core piece 40a, a second core piece 40b, and a third core piece 40c. Three first core pieces 40a and three second core pieces 40b are provided. Six third core pieces 40c are provided.

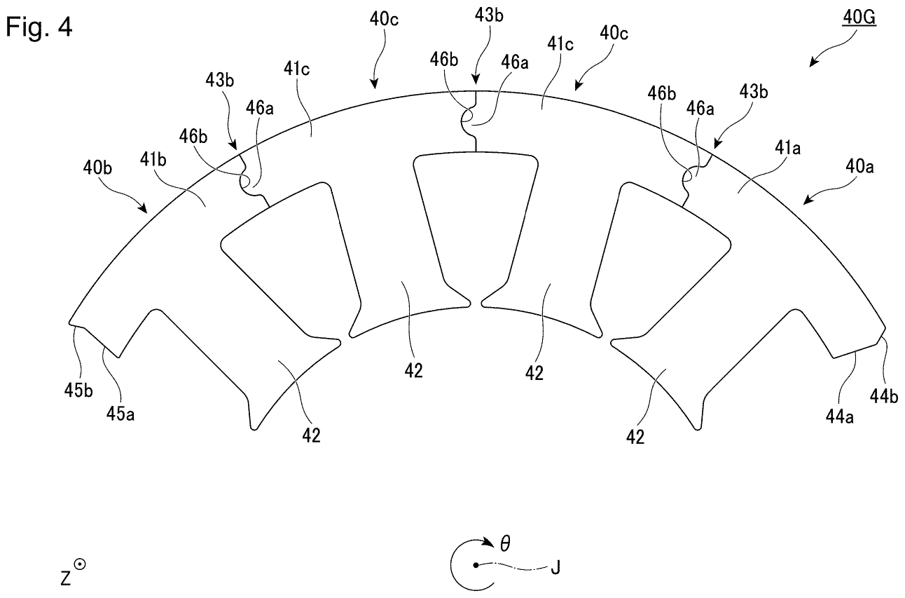

As illustrated in FIG. 4, in the present example embodiment, one first core piece 40a, one second core piece 40b, and two third core pieces 40c constitute a core piece group 40G. In the core piece group 40G, one first core piece 40a, two third core pieces 40c, and one second core piece 40b are disposed in this order from one circumferential direction side (+θ side) toward the other circumferential direction side (−θ side). In the core piece group 40G, the first core piece 40a and the second core piece 40b are disposed with the two third core pieces 40c interposed therebetween in the circumferential direction. As illustrated in FIG. 3, in the present example embodiment, three core piece groups 40G are provided side by side in the circumferential direction.

The core piece groups 40G adjacent to each other in the circumferential direction are connected to each other. More specifically, the core piece groups 40G adjacent to each other in the circumferential direction are connected to each other with the first core piece 40a included in one core piece group 40G and the second core piece 40b included in the other core piece group 40G connected to each other.

The first core piece 40a includes a first core back piece 41a as the core back piece 41p. The second core piece 40b includes a second core back piece 41b as the core back piece 41p. The first core piece 40a and the second core piece 40b adjacent to each other in the circumferential direction are connected to each other with the first core back piece 41a and the second core back piece 41b connected to each other in the circumferential direction. In the first core back piece 41a and the second core back piece 41b adjacent to each other in the circumferential direction, the second core back piece 41b is located on one circumferential direction side (+θ side) of the first core back piece 41a.

In the present example embodiment, of the coupling portion 43 between the core back pieces 41p adjacent to each other in the circumferential direction, the coupling portion 43 between the first core back piece 41a and the second core back piece 41b is a first coupling portion 43a. That is, in the present example embodiment, the first core back piece 41a and the second core back piece 41b correspond to a pair of core back pieces 41p connected in the circumferential direction via the first coupling portion 43a. In the present example embodiment, three first coupling portions 43a are provided, and three pairs of core back pieces 41p are provided.

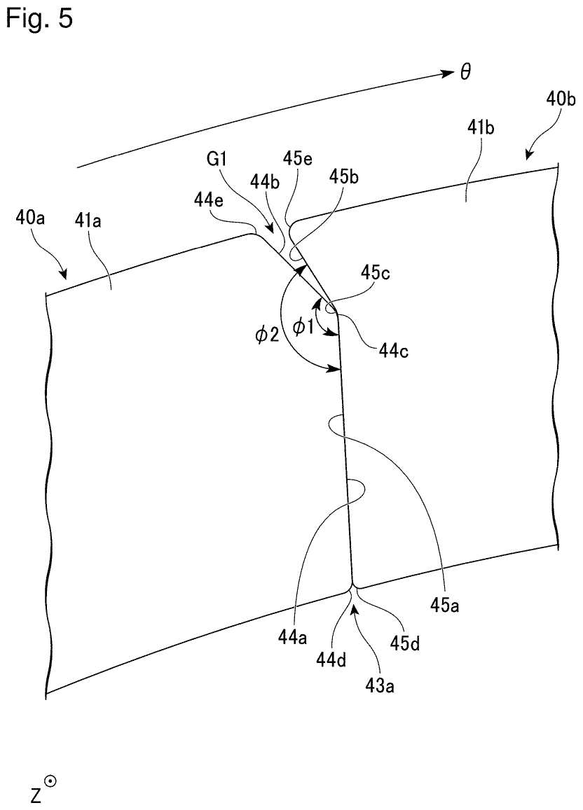

As illustrated in FIG. 5, the first core back piece 41a has a first surface 44a and a second surface 44b continuously connected to the first surface 44a in the radial direction. The second core back piece 41b has a first surface 45a and a second surface 45b continuously connected to the first surface 45a in the radial direction. That is, the pair of core back pieces 41p connected in the circumferential direction via the first coupling portion 43a has the first surfaces 44a and 45a and the second surfaces 44b and 45b continuously connected to the first surfaces 44a and 45a in the radial direction.

In the first core back piece 41a, the first surface 44a and the second surface 44b are part of the face of the first core back piece 41a on one circumferential direction side (+θ side). The first surface 44a and the second surface 44b are provided from one axial end to the other axial end of the first core back piece 41a.

When viewed in the axial direction, the first surface 44a linearly extends radially outward from an end on one circumferential direction side (+θ side) of the radially inner face of the first core back piece 41a in a direction inclined obliquely in the circumferential direction with respect to the radial direction. The first surface 44a is located on one circumferential direction side as it goes radially outward when viewed in the axial direction. The first surface 44a is a flat face facing one circumferential direction side and radially inward.

When viewed in the axial direction, the second surface 44b linearly extends radially outward from a radially outer end of the first surface 44a in a direction inclined obliquely in the circumferential direction with respect to the radial direction. The radially outer end of the second surface 44b is connected to the end of the radially outer face of the first core back piece 41a on one circumferential direction side (+θ side). In the present example embodiment, the circumferential position of the radially outer end of the second surface 44b is, for example, the same as the circumferential position of the radially inner end of the first surface 44a.

The second surface 44b is located on the other circumferential direction side (−θ side) as it goes radially outward when viewed in the axial direction. The second surface 44b is a flat face facing one circumferential direction side (+θ side) and radially outward. When viewed in the axial direction, the magnitude of the inclination of the second surface 44b with respect to the radial direction is larger than the magnitude of the inclination of the first surface 44a with respect to the radial direction. When viewed in the axial direction, the dimension of the second surface 44b in the direction in which the second surface 44b extends is smaller than the dimension of the first surface 44a in the direction in which the first surface 44a extends. The area of the second surface 44b is smaller than the area of the first surface 44a. That is, in the present example embodiment, the area of the first surface 44a is larger than the area of the second surface 44b. The ratio of the area of the first surface 44a to the area of the second surface 44b is, for example, 1.5 or more and 3.5 or less.

The connection portion 44d between the first surface 44a and the radially inner face of the first core back piece 41a is rounded when viewed in the axial direction. The connection portion 44d has an arc shape that is convex to one circumferential direction side (+θ side) and the radially inward when viewed in the axial direction. The connection portion 44e between the second surface 44b and the radially outer face of the first core back piece 41a is rounded when viewed in the axial direction. The connection portion 44e has an arc shape that is convex to one circumferential direction side and radially outward when viewed in the axial direction. The curvature radius of the connection portion 44d and the curvature radius of the connection portion 44e are, for example, the same.

In the first core back piece 41a, the first surface 44a and the second surface 44b constitute a convex corner portion 44c that is convex to one circumferential direction side (+θ side) when viewed in the axial direction. The convex corner portion 44c is convex toward the second core back piece 41b adjacent to the first core back piece 41a in the circumferential direction when viewed in the axial direction. In the present example embodiment, the top of the convex corner portion 44c is rounded. The top of the convex corner portion 44c is a connection portion between the first surface 44a and the second surface 44b. The top of the convex corner portion 44c has an arc shape that is convex to one circumferential direction side when viewed in the axial direction. The curvature radius of the top of the convex corner portion 44c is, for example, the same as the radius of curvature of the connection portion 44d and the radius of curvature of the connection portion 44e. The top of the convex corner portion 44c is located radially outside the radial center of the first core back piece 41a. The angle φ1 of the convex corner portion 44c is an obtuse angle. The angle φ1 is a smaller angle of the angles formed by the first surface 44a and the second surface 44b when viewed in the axial direction. The angle φ1 is, for example, 135° or more and 155° or less.

In the second core back piece 41b, the first surface 45a and the second surface 45b are part of the face of the second core back piece 41b on the other circumferential direction side (−θ side). The first surface 45a and the second surface 45b are provided from one axial end to the other axial end of the second core back piece 41b.

The first surface 45a linearly extends radially outward from an end on the other circumferential direction side (−θ side) of the radially inner face of the second core back piece 41b in a direction inclined obliquely in the circumferential direction with respect to the radial direction when viewed in the axial direction. The first surface 45a is located on one circumferential direction side (+θ side) as it goes radially outward when viewed in the axial direction. The first surface 45a is a flat face facing the other circumferential direction side and the radial outward. The first surface 45a is parallel to the first surface 44a of the first core back piece 41a. The first surface 45a is disposed to face one circumferential direction side of the first surface 44a. The first surface 44a of the first core back piece 41a and the first surface 45a of the second core back piece 41b are in contact with each other. When viewed in the axial direction, the dimension of the first surface 45a in the direction in which the first surface 45a extends is substantially the same as the dimension of the first surface 44a in the direction in which the first surface 44a extends. The area of the first surface 45a is substantially the same as the area of the first surface 44a.

The second surface 45b linearly extends radially outward from a radially outer end of the first surface 45a in a direction inclined obliquely in the circumferential direction with respect to the radial direction when viewed in the axial direction. The radially outer end of the second surface 45b is connected to the end of the radially outer face of the second core back piece 41b on the other circumferential direction side (−θ side). The second surface 45b is located on the other circumferential direction side as it goes radially outward when viewed in the axial direction. The second surface 45b is a flat face facing the other circumferential direction side and the radial inward.

When viewed in the axial direction, the magnitude of the inclination of the second surface 45b with respect to the radial direction is substantially the same as the magnitude of the inclination of the first surface 45a with respect to the radial direction. When viewed in the axial direction, the magnitude of the inclination of the second surface 45b with respect to the radial direction is smaller than the magnitude of the inclination of the second surface 44b of the first core back piece 41a with respect to the radial direction. When viewed in the axial direction, the dimension of the second surface 45b in the direction in which the second surface 45b extends is smaller than the dimension of the first surface 45a in the direction in which the first surface 45a extends and the dimension of the second surface 44b in the direction in which the second surface 44b extends. The area of the second surface 45b is smaller than the area of the first surface 45a and the area of the second surface 44b. That is, in the present example embodiment, the area of the first surface 45a is larger than the area of the second surface 45b. The ratio of the area of the first surface 45a to the area of the second surface 45b is, for example, 1.5 or more and 3.5 or less.

The second surface 45b is disposed to face one circumferential direction side (+θ side) of the second surface 44b with a gap G1 therebetween. That is, the second surface 44b of the first core back piece 41a and the second surface 45b of the second core back piece 41b are directed away from each other. The gap G1 extends in the axial direction. The gap G1 opens radially outward and to axially both sides. The gap G1 opens on the outer peripheral face of the stator core 40. The circumferential dimension of the gap G1 increases as it goes radially outward. That is, the second surface 44b and the second surface 45b are away from each other in the circumferential direction as it goes radially outward.

As described above, of the pair of core back pieces 41p connected in the circumferential direction via the first coupling portion 43a, the first surface 44a of one core back piece 41p (first core back piece 41a) and the first surface 45a of the other core back piece 41p (second core back piece 41i b) are in contact with each other, and the second surface 44b of the one core back piece 41p (first core back piece 41a) and the second surface 45b of the other core back piece 41p (second core back piece 41b) are directed away from each other. As described above, by providing the first surfaces 44a and 45a facing each other in contact with each other and the second surfaces 44b and 45b facing each other without being in contact with each other in each of the core back pieces 41p adjacent to each other of the circumferential direction, it is possible to reliably bring the first surfaces 44a and 45a into contact with each other while releasing variations caused by dimensional tolerances or the like by the distance of the gap G1 between the second surfaces 44b and 45b. Therefore, it is possible to suppress generation of an unintended gap between the core back pieces 41p connected via the first coupling portion 43a, and it is possible to stably secure the contact area between the core back pieces 41p by the area of the first surfaces 44a and 45a. As a result, it is possible to suppress variations in ease of flowing of the magnetic flux in the first coupling portion 43a, and it is possible to easily flow the magnetic flux into the first coupling portion 43a. Therefore, the magnetic flux can suitably flow through the stator core 40, and the torque ripple can be reduced.

In the present example embodiment, since the area of the first surfaces 44a and 45a are larger than the area of the second surfaces 44b and 45b, the contact area between the first core back piece 41a and the second core back piece 41b adjacent in the circumferential direction can be increased. As a result, the magnetic flux can more suitably flow through the stator core 40, and the torque ripple can be further reduced.

In addition, for example, when the first surfaces 44a and 45a are excessively larger than the second surfaces 44b and 45b, the second surfaces 44b and 45b may be excessively small, and the gap G1 between the second surfaces 44b and 45b may be excessively small. In this case, there is a possibility that dimensional tolerance or the like is hardly released by the gap G1. On the other hand, in the present example embodiment, the ratio of the area of the first surfaces 44a and 45a to the area of the second surfaces 44b and 45b is 1.5 or more and 3.5 or less. Therefore, it is possible to suppress the excessively small second surfaces 44b and 45b while suitably enlarging the first surfaces 44a and 45a. As a result, it is possible to suppress the excessively small gap G1 between the second surfaces 44b and 45b, and it is possible to suppress a state in which the dimensional tolerance and the like is difficult to escape by the gap G1. Therefore, the first surfaces 44a and 45a can be more reliably brought into contact with each other.

In the present example embodiment, the tooth 42 extends from the core back piece 41p to one radial direction side (radially inward), and the second surfaces 44b and 45b are connected to the other radial direction side (radially outward) of the first surfaces 44a and 45a. Therefore, the first surfaces 44a and 45a in contact with each other can be disposed in a portion of the core back 41 close to the tooth 42 in the radial direction, and the gap G1 between the second surfaces 44b and 45b can be disposed in a portion, of the core back 41, far from the tooth 42 in the radial direction. As a result, the magnetic flux flowing from the rotor 20 to the tooth 42 can easily flow to the contact portion between the first surfaces 44a and 45a, and the magnetic flux flowing through the contact portion between the first surfaces 44a and 45a can easily flow to the tooth 42. That is, it is possible to suitably suppress a state in which the flow of the magnetic flux in the stator core 40 is obstructed by the gap G1 between the second surfaces 44b and 45b. Therefore, the magnetic flux can more suitably flow through the stator core 40, and the torque ripple can more suitably be reduced.

In the present example embodiment, one radial direction side in which the tooth 42 extends from the core back piece 41p is a radially inner side, and the other radial direction side in which the second surfaces 44b and 45b are connected to the first surfaces 44a and 45a is a radially outer side. In such a case, since the distance between the tip portions of the plurality of teeth 42 in the circumferential direction is narrowed, it is difficult to attach the coil 50 to the teeth 42 when the stator core 40 is not divided into the plurality of core pieces 40p. On the other hand, in the present example embodiment, the stator core 40 is configured by the plurality of core pieces 40p. Therefore, when the core pieces 40p are connected to each other after attaching the coil 50 to the tooth 42 of each core piece 40p, the coil 50 can be easily attached to each tooth 42.

The connection portion 45d between the first surface 45a and the radially inner face of the second core back piece 41b is rounded when viewed in the axial direction. The connection portion 45d has an arc shape that is convex to the other circumferential direction side (−θ side) and the radially inward when viewed in the axial direction. The connection portion 45e between the second surface 45b and the radially outer face of the second core back piece 41b is rounded when viewed in the axial direction. The connection portion 45e has an arc shape that is convex to the other circumferential direction side and radially outward when viewed in the axial direction. The curvature radius of the connection portion 45d and the curvature radius of the connection portion 45e are, for example, the same. The curvature radius of the connection portion 45d and the curvature radius of the connection portion 45e are, for example, the same as the curvature radius of the connection portion 44d and the curvature radius of the connection portion 44e.

Of the second core back piece 41b, the first surface 45a and the second surface 45b constitute a concave corner portion 45c that is concave to one circumferential direction side (+θ side) when viewed in the axial direction. The concave corner portion 45c is recessed in a direction away from the first core back piece 41a adjacent to the second core back piece 41b in the circumferential direction when viewed in the axial direction. In the present example embodiment, the bottom of the concave corner portion 45c is rounded. The bottom of the concave corner portion 45c is a connection portion between the first surface 45a and the second surface 45b. The bottom of the concave corner portion 45c has an arc shape that is convex to one circumferential direction side when viewed in the axial direction. The curvature radius of the bottom of the concave corner portion 45c is smaller than, for example, the curvature radius of the connection portion 45d, the curvature radius of the connection portion 45e, and the curvature radius at the top of the convex corner portion 44c. This can prevent the second surface 44b of the convex corner portion 44c from interfering with the second surface 45b of the concave corner portion 45c. The bottom of the concave corner portion 45c is located radially outside the radial center of the second core back piece 41b.

The angle φ2 of the concave corner portion 45c is an obtuse angle. The angle φ2 is a smaller angle of the angles formed by the first surface 45a and the second surface 45b when viewed in the axial direction. The angle φ2 is, for example, 135° or more and 155° or less. The angle φ2 of the concave corner portion 45c is larger than the angle φ1 of the convex corner portion 44c. The difference between the angle φ1 of the convex corner portion 44c and the angle φ2 of the concave corner portion 45c is, for example, about 1° or more and 3° or less.

The convex corner portion 44c and the concave corner portion 45c face each other in the circumferential direction. Therefore, the top of the convex corner portion 44c can be engaged with the bottom of the concave corner portion 45c. As a result, it is possible to prevent the first core back piece 41a and the second core back piece 41b from being displaced from each other in the radial direction. Therefore, for example, when the stator core 40 is fixed in the housing 10, even when a radial force is applied to the stator core 40, it is possible to prevent the first core back piece 41a and the second core back piece 41b from being displaced from each other in the radial direction.

Here, in the present example embodiment, since the ratio of the area of the first surfaces 44a and 45a to the area of the second surfaces 44b and 45b is 1.5 or more and 3.5 or less, it is possible to prevent the area of the first surfaces 44a and 45a and the area of the second surfaces 44b and 45b from being greatly different from each other. As a result, it is possible to prevent the radial position of the top of the convex corner portion 44c constituted by the first surface 44a and the second surface 44b and the radial position of the bottom of the concave corner portion 45c constituted by the first surface 45a and the second surface 45b from being excessively close to the radial end of the core back 41. Therefore, the top of the convex corner portion 44c and the bottom of the concave corner portion 45c can be engaged with each other at a position relatively close to the radial center of the core back 41. Therefore, the first core back piece 41a and the second core back piece 41b adjacent to each other in the circumferential direction can be stably connected via the convex corner portion 44c and the concave corner portion 45c. As a result, it is possible to more suitably prevent the first core back piece 41a and the second core back piece 41b from being displaced from each other in the radial direction.

In the present example embodiment, the angle φ1 of the convex corner portion 44c and the angle φ2 of the concave corner portion 45c are obtuse angles. Therefore, it is easy to form each of the convex corner portion 44c and the concave corner portion 45c by punching or the like using a mold as compared with a case where the angle φ1 of the convex corner portion 44c and the angle φ2 of the concave corner portion 45c are acute angles.

Here, as the angle φ1 of the convex corner portion 44c and the angle φ2 of the concave corner portion 45c are increased, each of the convex corner portion 44c and the concave corner portion 45c can be easily formed by punching using a mold or the like. However, when the angle φ1 of the convex corner portion 44c and the angle φ2 of the concave corner portion 45c is excessively large, the top of the convex corner portion 44c and the bottom of the concave corner portion 45c are less likely to be engaged with each other, and the first core back piece 41a and the second core back piece 41b adjacent in the circumferential direction are less likely to be suitably caught in the radial direction. Therefore, when a radial force is applied to the stator core 40, the first core back piece 41a and the second core back piece 41b are easily displaced in the radial direction. On the other hand, in the present example embodiment, the angle φ1 of the convex corner portion 44c and the angle φ2 of the concave corner portion 45c are 135° or more and 155° or less. Therefore, it is possible to suppress the angle φ1 of the convex corner portion 44c and the angle φ2 of the concave corner portion 45c that are excessively large while suitably increasing the angle φ1 of the convex corner portion 44c and the angle φ2 of the concave corner portion 45c. As a result, the convex corner portion 44c and the concave corner portion 45c can be easily formed by punching or the like using a mold, and the convex corner portion 44c and the concave corner portion 45c can be suitably engaged with each other to suitably prevent the first core back piece 41a and the second core back piece 41b from being displaced in the radial direction.

As illustrated in FIG. 3, some coupling portions 43 of the coupling portion 43 between the core back pieces 41p adjacent to each other in the circumferential direction are second coupling portions 43b. In the present example embodiment, a plurality of second coupling portion 43b is provided. As illustrated in FIG. 4, three second coupling portion 43b are provided in one core piece group 40G. One second coupling portion 43b of the core piece group 40G is a second coupling portion 43b between the first core back piece 41a and the third core back piece 41c as the core back piece 41p included in the third core piece 40c. Another second coupling portion 43b of the core piece group 40G is a second coupling portion 43b between the second core back piece 41b and the third core back piece 41c. The remaining one second coupling portion 43b of the core piece group 40G is a second coupling portion 43b between the third core back pieces 41c. In the present example embodiment, since three core piece groups 40G are provided, a total of nine second coupling portion 43b are provided.

Of the core back pieces 41p connected in the circumferential direction via the second coupling portion 43b, a mating convex 46a that is convex to the other circumferential direction side is provided at an end, on the other circumferential direction side (−θ side), of the core back piece 41p located on one circumferential direction side (+θ side). The edge of the mating convex 46a on the other circumferential direction side has a substantially semicircular arc shape that is convex to the other circumferential direction side when viewed in the axial direction. Of the core back pieces 41p connected in the circumferential direction via the second coupling portion 43b, a mating recess 46b recessed to the other circumferential direction side is provided at an end, on one circumferential direction side, of the core back piece 41p located on the other circumferential direction side. The inner edge of the mating recess 46b has a substantially semicircular arc shape recessed to the other circumferential direction side when viewed in the axial direction. The mating convex 46a is fitted into the mating recess 46b. In the present example embodiment, the edge of the mating convex 46a on the other circumferential direction side is in contact with the inner edge of the mating recess 46b without a gap.

Each of the mating convex 46a and the mating recess 46b is located at the center of the core back piece 41p in the radial direction. Of the core back pieces 41p connected in the circumferential direction via the second coupling portion 43b, a portion, located on both sides in the radial direction of the mating convex 46a, of the end, on the other circumferential direction side (−θ side), of the core back piece 41p located on one circumferential direction side (+θ side) is in contact with a portion, located on both sides in the radial direction of the mating recess 46b, of the end, on one circumferential direction side, of the core back piece 41p located on the other circumferential direction side. In the present example embodiment, since the boundary portions between the core back pieces 41p of the second coupling portion 43b are formed by a pushback process described later, they are in contact with each other without a gap.

The first core back piece 41a of the first core piece 40a has the mating convex 46a at the end on the other circumferential direction side (−θ side). The second core back piece 41b of the second core piece 40b has the mating recess 46b at the end on one circumferential direction side (+θ side). The third core piece 40c has the mating recess 46b at the end on one circumferential direction side and has the mating convex 46a at the end on the other circumferential direction side.

As illustrated in FIG. 2, in the present example embodiment, each of the plurality of core pieces 40p is configured by a plurality of plates 48 stacked in the axial direction. The plates 48 of each core piece 40p are connected to the plates 48 of the core piece 40p adjacent in the circumferential direction. The stator core 40 is configured by a plurality of annular plates 49 stacked in the axial direction, the annular plates 49 being configured by a plurality of plates 48 connected to each other in the circumferential direction.

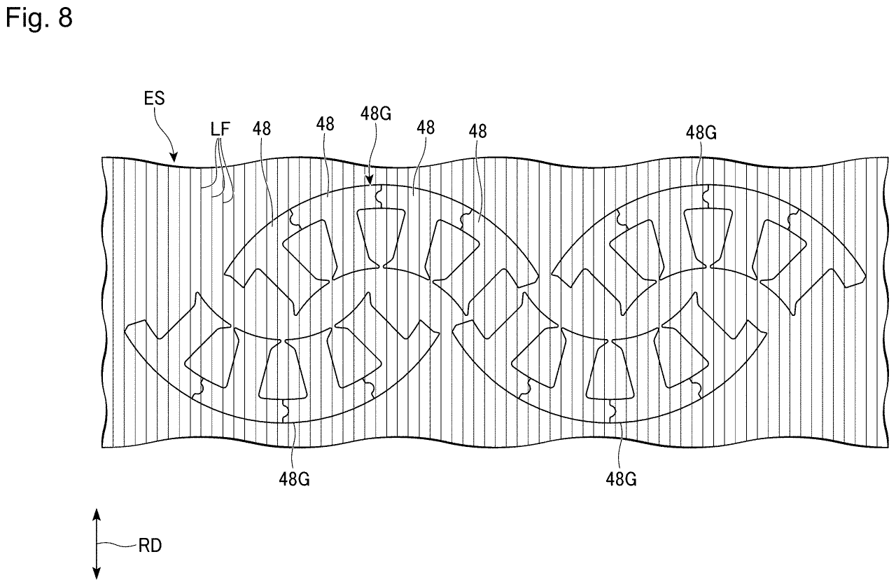

The material of the plate member 48 is a rolled steel material. More specifically, the material of the plate member 48 is an electromagnetic steel plate. Each plate member 48 is formed by punching a base material made of an electromagnetic steel plate with a mold. As illustrated in FIG. 3, the surface of each plate member 48 facing the axial direction has an infinite number of linear flaws LF generated in the rolled steel material by rolling. The direction in which the linear flaw LF extends is a direction in which the rolled steel material constituting the plate member 48 is rolled, that is, a rolling direction. In FIG. 3, the linear flaw LF is shown continuously and regularly, but the present invention is not limited thereto. The linear flaw LF may be intermittently and irregularly provided on the surface of the plate member 48 as long as the linear flaw LF extends in the rolling direction. The same applies to FIG. 8 described later.

In the present example embodiment, the rolling directions of the plates 48 of the core pieces 40p connected in the circumferential direction via the first coupling portion 43a are different from each other. That is, in the first core piece 40a and the second core piece 40b adjacent to each other in the circumferential direction, the directions in which the linear flaws LF of the plate member 48 extend are different from each other. In the present example embodiment, the rolling directions of the plates 48 of the core pieces 40p connected in the circumferential direction via the second coupling portion 43b are equal to each other. That is, the first core piece 40a and the third core piece 40c adjacent to each other in the circumferential direction have the same direction in which the linear flaws LF of the plate member 48 extend, the second core piece 40b and the third core piece 40c adjacent to each other in the circumferential direction have the same direction in which the linear flaws LF of the plate member 48 extend, and the third core pieces 40c adjacent to each other in the circumferential direction have the same direction in which the linear flaws LF of the plate member 48 extend.

In each annular plate member 49, the direction in which the linear flaw LF of the plate member 48 extends, that is, the rolling direction is different for each core piece group 40G. That is, in each annular plate member 49, the directions in which the linear flaws LF of the plates 48 included in the same core piece group 40G extend are the same as each other, and the directions in which the linear flaws LF of the plates 48 included in different core piece groups 40G extend are different from each other. The directions in which the linear flaws LF extend in the plates 48 adjacent to each other in the axial direction of the same core piece 40p may be the same or different from each other.

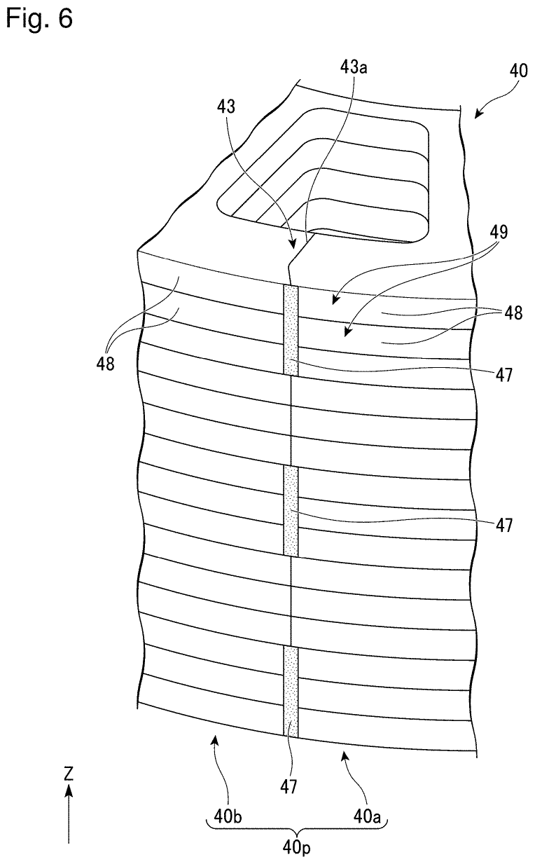

As illustrated in FIG. 6, a welded portion 47 is provided on the outer peripheral face of the stator core 40 of the present example embodiment. The welded portion 47 is a portion formed by welding part of the outer peripheral face of the stator core 40. The welded portion 47 is provided at a radially outer end of the coupling portion 43 between the core pieces 40p adjacent to each other in the circumferential direction. The welded portion 47 fixes the core pieces 40p adjacent to each other in the circumferential direction. A plurality of welded portions 47 is provided on the coupling portion 43 at intervals in the axial direction. FIG. 6 shows an example in which three welded portions 47 are provided at the radially outer end of the first coupling portion 43a. Each welded portion 47 extends in the axial direction. In the portion, of the first coupling portion 43a, where the welded portion 47 is provided, part of the welded portion 47 may enter the gap G1 between the second surfaces 44b and 45b of the first coupling portion 43a, and the second surfaces 44b and 45b may be connected to each other by part of the welded portion 47. Even in this case, by bringing the first surfaces 44a and 45a into contact with each other before welding, the first core back piece 41a and the second core back piece 41b adjacent to each other in the circumferential direction can be suitably brought into contact with each other.

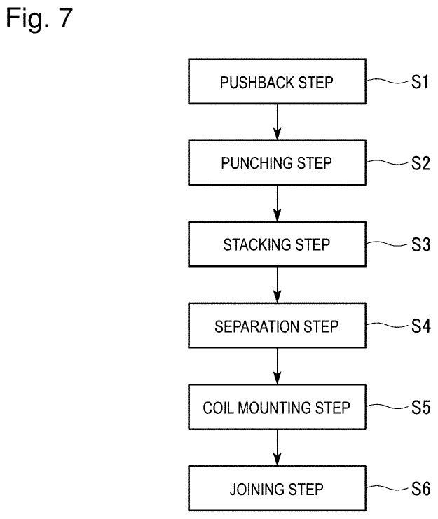

Next, a method of manufacturing the stator 30 of the present example embodiment will be described. As illustrated in FIG. 7, the method for manufacturing the stator 30 in the present example embodiment includes a pushback step S1, a punching step S2, a stacking step S3, a separation step S4, a coil mounting step S5, and a joining step S6.

As illustrated in FIG. 8, the pushback step S1 is a step of performing a pushback process on a rolled steel material ES as a base material. The rolled steel material ES is, for example, an electromagnetic steel plate. The vertical direction in FIG. 8 is a rolling direction RD of the rolled steel material ES. The surface of the rolled steel material ES has a plurality of linear flaws LF extending in the rolling direction RD. In the pushback step S1, the operator or the like presses the metal mold against the rolled steel material ES from one side in the plate thickness direction, cuts part of the rolled steel material ES into the shape of the plate member 48, and then pushes back the cut portion from the other side in the plate thickness direction by another metal mold. As a result, the cut portion is not separated from the rolled steel material ES, and a boundary portion cut into the outer shape of the plate member 48 is formed in the rolled steel material ES. In the pushback step S1 of the present example embodiment, the operator or the like forms the boundary portion for each plate member group 48G. The plate member group 48G is configured by the plates 48 constituting four core pieces 40p included in the core piece group 40G connected one by one to each other in the circumferential direction. The core piece group 40G is configured by a plurality of plate member groups 48G stacked in the axial direction.

In the present specification, the “operator or the like” includes an operator who performs each work, an assembly device, or the like. Each work may be performed only by an operator, may be performed only by an assembling device, or may be performed by an operator and an assembling device.

The punching step S2 is a step of punching the plate member group 48G from the rolled steel material ES. In the punching step S2, the operator or the like separates a boundary portion along the outer shape of the plate member group 48G of the boundary portions formed in the pushback step S1 using a mold or the like, and punches the plate member group 48G from the rolled steel material ES in a state where the four plates 48 are connected.

In the present example embodiment, a plurality of plate member groups 48G disposed in a line at intervals along a direction orthogonal to both the rolling direction RD and the plate thickness direction of the rolled steel material ES on the rolled steel material ES, that is, the left-right direction in FIG. 8, is punched out from the rolled steel material ES. In the present example embodiment, the plurality of plate member groups 48G disposed in the line is provided in a plurality of rows along the rolling direction RD. The plate member groups 48G included in the rows adjacent to each other are shifted from each other in the left-right direction of FIG. 8 by about the width of one plate member 48 in the left-right direction, and are in a posture reversed from each other in the rolling direction RD. Further, part of the plate member groups 48G included in the rows adjacent to each other includes portions whose positions in the rolling direction RD are the same. By punching out the plurality of plate member groups 48G from the rolled steel material ES in this manner, it is possible to improve the yield when manufacturing the plate member 48.

Further, since the plates 48 are punched out from the rolled steel material ES for each plate member group 48G constituting the core piece group 40G, the rolling directions of the plates 48 of the core pieces 40p connected in the circumferential direction in the core piece group 40G are equal to each other. That is, the rolling directions of the plates 48 of the core pieces 40p connected in the circumferential direction via the second coupling portion 43b are equal to each other. As described above, when the plate member group 48G constituting the core piece group 40G is punched out from the rolled steel material ES, by punching out the plate member group 48G after using the pushback process as described above, it is possible to suppress generation of a gap in the coupling portion between the plates 48 of the plate member group 48G. Accordingly, it is possible to suppress generation of a gap between the core pieces 40p in the circumferential direction in the second coupling portion 43b. Therefore, the magnetic flux can suitably flow through the second coupling portion 43b, and the torque ripple can be further reduced.

In addition, since the plates 48 are punched out from the rolled steel material ES for each plate member group 48G constituting the core piece group 40G, the core piece groups 40G adjacent to each other in the circumferential direction have different rolling directions of the plates 48 of the core pieces 40p. That is, the rolling directions of the plates 48 of the core pieces 40p connected in the circumferential direction via the first coupling portion 43a are different from each other. Here, for example, by adopting a method of punching the annular plate member 49 in which the plurality of plates 48 is annularly connected from the rolled steel material ES, it is possible to suitably suppress generation of a gap in the coupling portion between all the core pieces 40p by using the pushback process. However, in this case, the portion, of the rolled steel material ES located, inside the annular plate member 49 cannot be used as a material for manufacturing the plates 48, and there is a problem that the yield at the time of manufacturing the plates 48 decreases.

On the other hand, in the present example embodiment, since each plate member group 48G is punched out from the rolled steel material ES, for example, the yield can be improved by punching the plurality of plate member groups 48G as illustrated in FIG. 8. On the other hand, the coupling portion 43 between the core piece groups 40G cannot form a boundary portion, in a state of being connected, portion by the pushback process, and thus cannot be formed without a gap unlike the second coupling portion 43b. However, in the present example embodiment, as described above, by forming the coupling portion 43 between the core piece groups 40G as the first coupling portion 43a having the first surfaces 44a and 45a and the second surfaces 44b and 45b, the contact area between the core pieces 40p connected via the first coupling portion 43a can be suitably secured. Therefore, according to the present example embodiment, the yield in manufacturing the stator core 40 can be improved, the magnetic flux can easily flow through each of the first coupling portion 43a and the second coupling portion 43b, and the torque ripple can be suitably reduced.

When the method of punching the annular plate member 49 in which the plurality of plates 48 is annularly connected from the rolled steel material ES is used, it is conceivable to use a portion, of the rolled steel material ES, located inside the annular plate member 49 as a material for manufacturing the laminated steel plate constituting the rotor core of the rotor 20. In this case, it is possible to suppress a decrease in the yield of the rotating electrical machine 100. In this case, the material constituting the plate member 48 of the stator core 40 and the material constituting the laminated steel plate of the rotor core are the same. Here, the quality required for the material constituting the laminated steel plate of the rotor core is lower than the quality required for the material constituting the plate member 48 of the stator core 40. Therefore, in a case where the material constituting the plate member 48 of the stator core 40 and the material constituting the laminated steel plate of the rotor core are the same, an expensive material having higher quality than necessary is used for the material constituting the laminated steel plate of the rotor core, and there is a problem that the manufacturing cost of the rotating electrical machine 100 increases. On the other hand, in the present example embodiment, as described above, the yield can be improved without using part of the rolled steel material ES for manufacturing the stator core 40 for a material for forming the laminated steel plate of the rotor core. Therefore, it is possible to suppress an increase in manufacturing cost of the rotating electrical machine 100.

The stacking step S3 is a step of stacking a plurality of plate member groups 48G punched in the punching step S2 to form a core piece group 40G. In the stacking step S3, the operator or the like fixes the plates 48 adjacent to each other in the stacking direction of the stacked plate member groups 48G by crimping or the like.

The separation step S4 is a step of separating the four core pieces 40p constituting the core piece group 40G from each other. The coil mounting step S5 is a step of mounting the coil 50 on the tooth 42 of each core piece 40p separated in the separation step S4. The joining step S6 is a step of assembling the stator core 40 by connecting the core pieces 40p to each other in the circumferential direction after the coil 50 is mounted. In the joining step S6, the operator or the like joins 12 core pieces 40p formed by dividing the three core piece groups 40G in the circumferential direction to assemble the stator core 40. In the joining step S6, the operator or the like welds the coupling portion 43 of the core piece 40p from the radially outer side, forms the welded portion 47, and fixes the core pieces 40p adjacent to each other in the circumferential direction. Through the above steps, the annular stator core 40 in which the coils 50 are attached to respective teeth 42 is manufactured, and the stator 30 is manufactured.

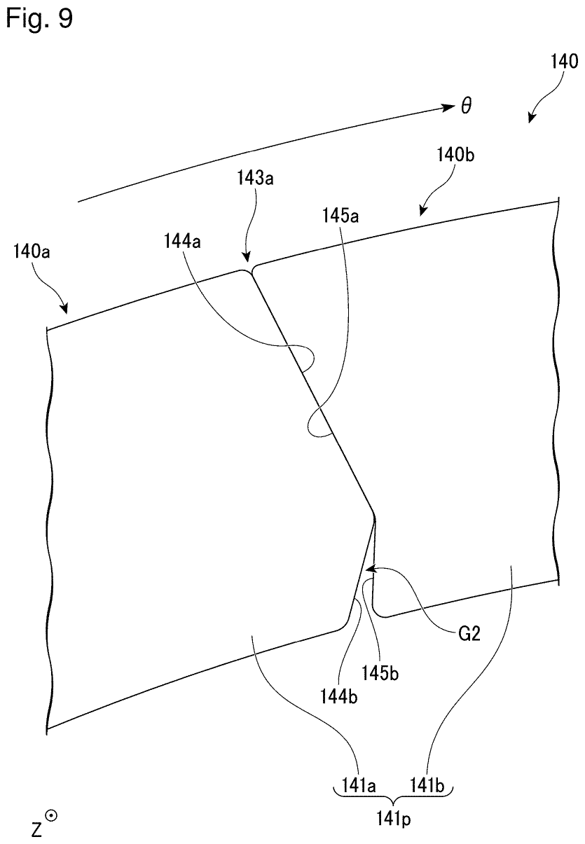

In the following description, the same reference numerals are appropriately given to the same configurations as those of the above-described example embodiment, and the description thereof may be omitted. As illustrated in FIG. 9, in a first coupling portion 143a of the stator core 140 of the present example embodiment, the second surfaces 144b and 145b are connected to the radially outer side of the first surfaces 144a and 145a. That is, in the present example embodiment, the second surfaces 144b and 145b are respectively connected to the side same as the side in which the tooth 42 extend from the core back piece 141p in the radial direction of the first surfaces 144a and 145a.

The first surface 144a and the second surface 144b are provided on the core back piece 141a of the core piece 140a, located on the other circumferential direction side (−θ side), of the pair of core pieces 140a and 140b connected in the circumferential direction via the first coupling portion 143a. The first surface 145a and the second surface 145b are provided on the core back piece 141b of the core piece 140b, located on one circumferential direction side (+θ side), of the pair of core pieces 140a and 141b connected in the circumferential direction via the first coupling portion 143a.

The shape of the first coupling portion 143a is a shape obtained by inverting the first coupling portion 43a of the first example embodiment in the radial direction. In the present example embodiment, the gap G2 between the second surfaces 144b and 145b is open radially inward. The circumferential dimension of the gap G2 increases it goes radially inward. Other configurations of the respective portions of the stator core 140 are similar to the other configurations of the respective portions of the stator core 40 of the first example embodiment.

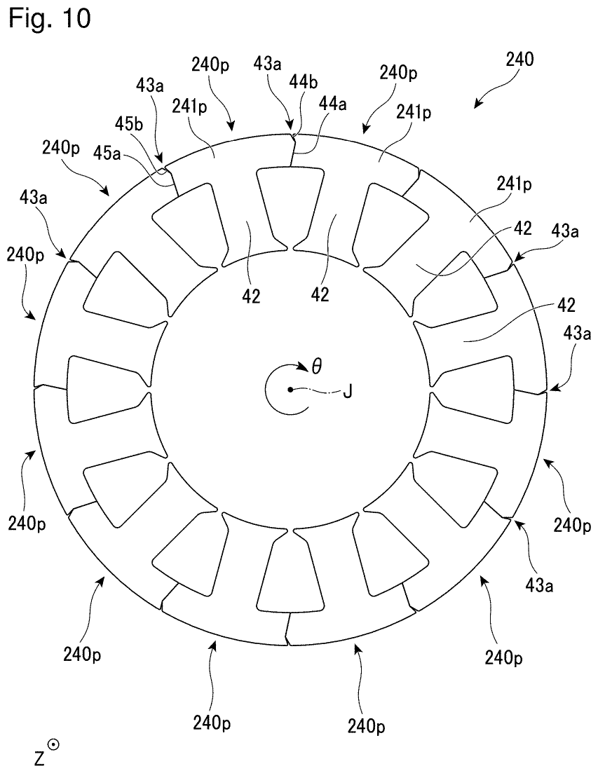

In the following description, the same reference numerals are appropriately given to the same configurations as those of the above-described example embodiment, and the description thereof may be omitted. As illustrated in FIG. 10, in the stator core 240 of the present example embodiment, all the coupling portions between the core pieces 240p adjacent to each other in the circumferential direction are first coupling portions 43a. Therefore, the shapes of the core back pieces 241p in the core pieces 240p can be the same as each other, and the shapes of the core pieces 240p can be the same as each other. As a result, the number of mold for punching the plurality of plates 48 constituting the core pieces 240p can be one, and it is possible to reduce the manufacturing cost of the stator core 240.

The core back piece 241p of each core piece 240p has a first surface 44a and a second surface 44b at an end on one circumferential direction side (+θ side), and has a first surface 45a and a second surface 45b at an end on the other circumferential direction side (−θ side). Other configurations of the respective portions of the stator core 240 are similar to the other configurations of the respective portions of the stator core 40 of the first example embodiment.

The present invention is not limited to the above-described example embodiment, and other structures and other methods may be employed within the scope of the technical idea of the present invention. At least one of the coupling portions between the core back pieces adjacent in the circumferential direction may be the first coupling portion. That is, the number of the first coupling portions is not particularly limited as long as it is one or more. The coupling portion between the core back pieces adjacent to each other in the circumferential direction may not include the second coupling portion as in the third example embodiment described above, or may include a third coupling portion having a structure different from both the first coupling portion and the second coupling portion. The structure of the second coupling portion is not particularly limited, and may be the same as that of the first coupling portion.

Each of the pair of core back pieces connected in the circumferential direction via the first coupling portion may have any shape as long as it has the first surface and the second surface continuously connected to the first surface in the radial direction. As long as the first surfaces are in contact with each other between the pair of core back pieces connected in the circumferential direction via the first coupling portion, the first surface may be a face facing any direction or a face having any shape. The second surface may have any shape, and may be configured by two or more flat faces connected. The area of the first surface and the area of the second surface are not particularly limited. The area of the first surface may be smaller than the area of the second surface, or may be the same as the area of the second surface. The connection portion between the first surface and the radially outer face or the radially inner face of the core back piece, and the connection portion between the second surface and the radially outer face or the radially inner face of the core back piece may not be rounded, and may have an acute angular corner shape.

In one core back piece of the pair of core back pieces connected in the circumferential direction via the first coupling portion, the first surface and the second surface may not form a convex corner portion that is convex toward the other core back piece when viewed in the axial direction. Further, in the other core back piece, the first surface and the second surface may not form a concave corner portion that is concave in a direction away from the one core back piece when viewed in the axial direction. The angle of the convex corner portion and the angle of the concave corner portion are not particularly limited. The top of the convex corner portion and the bottom of the concave corner portion may not be rounded, and may have an acute angular corner shape.

The rotating electrical machine to which the present invention is applied may be an outer rotor type motor. In this case, for example, one radial direction side in which the tooth extends from the core back piece is the radially outer side, and the other radial direction side opposite to the one radial direction side is the radially inner side. The rotating electrical machine is not limited to a motor, and may be a power generator. A use of the rotating electrical machine is not particularly limited. The rotating electrical machine may be mounted on a vehicle or may be mounted on a device other than the vehicle. The structures and methods described above in the present specification can be appropriately combined within a range consistent with each other.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A rotating electrical machine comprising:
a rotor rotatable about a center axis; and
a stator including an annular stator core including core pieces connected to each other in a circumferential direction, the stator radially opposing the rotor with a gap interposed therebetween; wherein
each of the core pieces includes:
a core back piece extending in the circumferential direction; and
a tooth radially extending from the core back piece;
the core back pieces are connected to each other in the circumferential direction to define an annular core back;
at least one of coupling portions between the core back pieces adjacent to each other in the circumferential direction is a first coupling portion;
each of the pair of core back pieces connected in the circumferential direction via the first coupling portion includes a first surface and a second surface continuously connected to the first surface in a radial direction; and
in the pair of core back pieces connected in the circumferential direction via the first coupling portion:
the first surface of one core back piece and the first surface of another core back piece are in contact with each other; and
the second surface of the one core back piece and the second surface of other core back piece are directed away from each other.

2. The rotating electrical machine according to claim 1, wherein a total area of the first surface is larger than a total area of the second surface.

3. The rotating electrical machine according to claim 2, wherein a ratio of the area of the first surface to the area of the second surface is about 1.5 or more and about 3.5 or less.

4. The rotating electrical machine according to claim 1, wherein
the first surface and the second surface of the one core back piece include a convex corner portion that is convex toward the other core back piece when viewed in an axial direction;
the first surface and the second surface of the other core back piece include a concave corner portion that is concave in a direction away from the one core back piece when viewed in the axial direction;
an angle of the concave corner portion is larger than an angle of the convex corner portion; and
the convex corner portion and the concave corner portion oppose each other in the circumferential direction.

5. The rotating electrical machine according to claim 4, wherein the angle of the convex corner portion and the angle of the concave corner portion are obtuse angles.

6. The rotating electrical machine according to claim 5, wherein the angle of the convex corner portion and the angle of the concave corner portion are about 135° or more and about 155° or less.

7. The rotating electrical machine according to claim 1, wherein
the tooth extends from the core back piece toward one radial direction side; and
the second surface is connected to another radial direction side of the first surface.

8. The rotating electrical machine according to claim 7, wherein
the one radial direction side is a radially inner side; and
the other radial direction side is a radially outer side.

9. The rotating electrical machine according to claim 1, wherein
each of the plurality of core pieces includes plates stacked in an axial direction;
a material of each of the plates is a rolled steel material;
some coupling portions of the coupling portions between the core back pieces adjacent to each other in the circumferential direction are second coupling portions; and
rolling directions of the plates of the core pieces connected to each other in the circumferential direction via each of the second coupling portions are equal or substantially equal to each other.

10. The rotating electrical machine according to claim 9, wherein rolling directions of the plates of the core pieces connected to each other in the circumferential direction via the first coupling portion are different from each other.

11. The rotating electrical machine according to claim 1, wherein all the coupling portions between the core back pieces adjacent to each other in the circumferential direction are the first coupling portions.
